(19) United States
(12) Patent Application Publication
(10) Pub. No.: US 2004/0257283 A1
(43) Pub. Date: Dec. 23, 2004

(54) Antennas integrated with metallic display covers of computing devices

(75) Inventors: Takeshi Asano, Atsugi (JP); Shohhei Fujio, Tokyo (JP); Brian Paul Gaucher, Brookfield, CT (US); Peter Lee, Chapel Hill, NC (US); Duixian Liu, Yorktown Heights, NY (US); Kazuo Masuda, Kamakura-shi (JP)

Correspondence Address: F. CHAU & ASSOCIATES, LLC, 130 WOODBURY ROAD, WOODBURY, NY, 11797, US

(73) Assignee: International Business Machines Corporation

(21) Appl. No.: 10/465,684

(22) Filed: Jun. 19, 2003

(51) Int. Cl. H01Q 1/24

(52) U.S. Cl. 343/702

(57) ABSTRACT

Antennas for use with computing devices such as laptop computers. In one embodiment, the antennas are integrally formed on a metallic covering of a computing device. In another embodiment, the antennas are integrally formed on a metallic cover of a display unit of a laptop device. For instance, one or more antennas are integrally formed on one or more of the bent edges (sidewalls) of the metallic cover of a display unit (i.e., sides of the cover that are perpendicular to the plane of an LCD unit). In other embodiments, one or more antennas are integrally formed on the metallic cover of the display unit in areas between the LCD and the sidewalls.

### TECHNICAL FIELD OF THE INVENTION

The present invention relates generally to antennas for use with computing devices such as laptop computers. More specifically, the invention relates to antennas that are integrally formed with, and part of, metallic display covers of computing devices.

### BACKGROUND

To provide wireless connectivity between a computing device (e.g., portable laptop computer) and other computing devices (laptops, servers, etc.), peripherals (e.g., printers, mouse, keyboard, etc.) or communication devices (modem, smart phones, etc.), it is necessary to equip such devices with antennas. For example, with portable laptop computers, an antenna may be located either external to the device or integrated (embedded) within the device (e.g., embedded in the display unit).

For example, FIG. 1 is a diagram illustrating various embodiments for providing external antennas for a laptop computer. For instance, an antenna (100) can be located at the top of a display unit of the laptop. Alternatively, an antenna (101) can be located on a PC card (102). The laptop computer will provide optimum wireless connection performance when the antenna is mounted on the top of the display due to the very good RF (radio frequency) clearance. There are disadvantages, however, associated with laptop designs with external antennas including, for example, high manufacture costs, possible reduction of the strength of the antenna (e.g., for a PC card antenna (102)), susceptibility of damage, and the effects on the appearance of the laptop due to the antenna.

Other conventional laptop antenna designs include embedded designs wherein one or more antennas are integrally built (embedded antenna) within a laptop. For example, FIG. 2 illustrates conventional embedded antenna implementations, wherein one or more antennas (200, 201, 202) (e.g., whip-like or slot embedded antenna) are embedded in a laptop display. In one conventional embodiment, two antennas are typically used (although applications implementing one antenna are possible). In particular, two embedded antennas (200, 201) can be placed on the left and right edges of the display. The use of two antennas (as opposed to one antenna) will reduce the blockage caused by the display in some directions and provide space diversity to the wireless communication system.

In another conventional configuration, one antenna (200 or 201) is disposed on one side of the display and a second antenna (202) is disposed in an upper portion of the display. This antenna configuration may also provide antenna polarization diversity depending on the antenna design used.

Although embedded antenna designs can overcome some of the above-mentioned disadvantages associated with external antenna designs (e.g., less susceptible to damage), embedded antenna designs typically do not perform as well as external antennas. To improve the performance of an embedded antenna, the antenna is preferably disposed at a certain distance from any metal component of a laptop. For example, depending on the laptop design and the antenna type used, the distance between the antenna and any metal component should be at least 10 mm. Another disadvantage associated with embedded antenna designs is that the size of the laptop must be increased to accommodate antenna placement, especially when two or more antennas are used (as shown in FIG. 2).

Continuing advances in wireless communications technology has lead to significant interest in development and implementation of wireless computer applications. For instance, spontaneous (ad hoc) wireless network connectivity can be implemented using the currently emerging “Bluetooth” networking protocol. Briefly, Bluetooth is a protocol for providing short-range wireless radio links between Bluetooth-enabled devices (such as smartphones, cellular phone, pagers, PDAs, laptop computers, mobile units, etc.). Bluetooth enabled devices comprise a small, high performance, low-power, integrated radio transceiver chip comprising a baseband controller for processing input/output baseband signals using a frequency-hop spread-spectrum system, as well as a modulator/demodulator for modulating and demodulating a carrier frequency in the 2.4 GHz ISM (industrial-scientific-medical) band.

Currently, the 2.4 GHz ISM band is widely used in wireless network connectivity. By way of example, many laptop computers incorporate Bluetooth technology as a cable replacement between portable and/or fixed electronic devices and IEEE 802.11b technology for WLAN (wireless local area network). If an 802.11b device is used, the 2.4 GHz band can provide up to 11 Mbps data rate.

To provide even higher data rates and provide compatibility with worldwide wireless communication applications and environments, it is desirable to provide wireless devices that operate, for example, using the 5 GHz U-NII (unlicensed national information infrastructure). For example, U-NII devices operating on the 5.15-5.35 GHz frequency range can provide data rates up to 54 Mbps and even higher data rates can be obtained by operating in the 5.47-5.825 GHz band, for example.

Recently, novel embedded antenna designs have been proposed which enable computing devices, such as laptop computers, to operate in the 2.4-2.5 GHz, 5.15-5.35 GHz and/or 5.47-5.825 GHz bands, for example, and which provide significant improvements over conventional embedded antenna designs. For example, U.S. Pat. No. 6,339,400, issued to Flint et al. on Jan. 15, 2002, entitled “Integrated Antenna For Laptop Applications”, and U.S. patent application Ser. No. 09/876,557, filed on Jun. 7, 2001, entitled “Display Device, Computer Terminal and Antenna,” which are commonly assigned and incorporated herein by reference, disclose various embedded single-band antenna designs for laptop computers, which may be implemented to operate in the 2.4 GHZ ISM band frequency band, for example.

Furthermore, U.S. patent application Ser. No. 09/866,974, filed on May 29, 2001, entitled “An Integrated Antenna for Laptop Applications”, and U.S. patent application Ser. No. 10/370,976, filed on Feb. 20, 2003, entitled “An integrated Dual-Band Antenna for Laptop Applications,” both of which are commonly assigned and incorporated herein by reference, describe embedded dual-band antennas that may be implemented with laptop computers, which may be implemented to operate in both the 2.4 Ghz ISM band and the 5.15-5.35 GHZ bands, for example.

In addition, U.S. patent application Ser. No. 10/318,816, filed on Dec. 13, 2002, entitled “An Integrated Tri-Band Antenna for Laptop Applications”, which is commonly assigned and incorporated herein by reference, discloses various embedded tri-band antennas for laptop computers that can operate in the 2.4-2.5 GHz, 5.15-5.35 GHz and 5.47-5.825 GHz bands, for example.

The above incorporated Patents and Patent applications describe various embedded (integrated) antennas that can be mounted on a metallic support frame or rim of a display device (e.g., LCD panel), or other internal metal support structure, as well as antennas that can be integrally formed on RF shielding foil that is located on the back of the display unit. For example, antennas can be designed by patterning one or more antenna elements on a PCB, and then connecting the patterned PCB to the metal support frame of the display panel, wherein the metal frame of the display unit is used as a ground plane for the antennas. A coaxial transmission line is preferably used to feed an embedded antenna, wherein the center conductor is coupled to a radiating element of the antenna and the outer (ground connector) is coupled to the metal rim of the display unit. Advantageously, these embedded (integrated) antenna designs support many antenna types, such as slot antennas, inverted-F antennas and notch antennas, and provide many advantages such as smaller antenna size, low manufacturing costs, compatibility with standard industrial laptop/display architectures, and reliable performance.

FIGS. 3 and 4 are schematic diagrams illustrating various orientations for mounting integrated antennas on a laptop display unit as disclosed in the above incorporate patents and applications. For example, FIG. 3 schematically illustrates a pair of dual-band antennas (301, 302) that are mounted to a metal support frame (303) of a laptop display unit (or a metal rim of an LCD), wherein a plane of each dual-band antenna (301, 302) is substantially parallel to the plane (or along the plane) of the support frame (303). FIG. 4 illustrates a pair of dual-band antennas 401, 402 that are mounted to a metal support frame (303) of the laptop display unit, wherein a plane of each of the dual-band antennas (401, 402) is disposed substantially perpendicular to a plane of support frame (303). FIG. 4 shows the integrated antennas perpendicular to the LCD. The antennas are mounted on metal rim of LCD or on the metal support structure of the display. In most laptop display design, this is a space saving implementation. Advantageously, with respect to laptop computers, for example, the embedded antenna designs of the above-incorporated patents and applications provide a space saving implementation, whereby the display cover of the display unit does not have to be larger than necessary to accommodate these antennas (which is to be contrasted with the conventional embedded designs as illustrated in FIG. 2).

A conventional design for display units of portable laptop computers employs plastic display covers, such as ABS plastics, which requires metal foil to be placed inside the plastic cover to provide the necessary RF shielding to meet regulatory emission requirements. Furthermore, the plastic display cover are typically thick to ensure that the plastic cover is mechanically strong and provides the structural integrity needed for portable laptop applications. Unfortunately, portable laptop computers made with plastic covers tend to be heavier and larger than portable laptop computers having covers that are made of other materials. For instance, to reduce the laptop weight, more expensive cover materials, such as carbon-filled plastics, may be used. Since these materials are very lossy, the metal foil for RF shielding is not required. Furthermore, laptop covers that are made of such carbon-filled plastics tend to be made thinner than laptop covers that are made of pure plastic cover.

Recently, portable laptop devices have been designed using metallic covers to provide lighter weight devices, as well as to provide a sleek appearance. Advantageously, by using lightweight metallic materials, such as aluminum and magnesium, the laptop covers can be made very thin while providing the necessary structural integrity. When an integrated antenna is placed inside a laptop device having a metallic cover, the antenna performance tends to deteriorate since the metallic cover can block the antenna radiation and increase the Q factor of the antenna, resulting in a narrower antenna bandwidth and low antenna efficiency.

### SUMMARY OF THE INVENTION

It is to be appreciated that in addition to providing lightweight devices, the use of metallic covers affords significant opportunities for new antenna designs. Indeed, in accordance with the present invention, antennas are integrally formed as part of the metallic covering of a computing device such as a laptop computer. Antenna designs according to the present invention provide improved performance with reduced manufacturing costs.

In general, the present invention is directed to antennas for use with computing devices such as laptop computers. In one embodiment, the antennas are integrally formed on a metallic covering of a computing device. In another embodiment, the antennas are integrally formed on a metallic cover of a display unit of a laptop device. For instance, one or more antennas are integrally formed on one or more of the bent edges (sidewalls) of the metallic cover of a display unit (i.e., sides of the cover that are perpendicular to the plane of an LCD unit). In other embodiments, one or more antennas are integrally formed on the metallic cover of the display unit in areas between the LCD and the sidewalls.

More specifically, in one embodiment of the invention, a computing device comprises a display unit having a display screen and a metallic display cover, and an antenna that is integrally formed on the metallic cover of the display unit. The metallic display cover comprises first sidewalls that are perpendicular to a plane of the display screen and second sidewalls that are parallel to the plane of the display screen. The antenna can be integrally formed on one of the first sidewalls, or on a second sidewalls in an area located between the display screen and a first sidewall.

In another embodiment, the antenna is a single-band antenna having a resonant frequency in a frequency band. The antenna may comprise a single slot element, a single inverted-F element, or a plurality of slot elements.

In another embodiment, the antenna is a dual-band antenna comprising a first element having a first resonant frequency in a first frequency band, and a second element having a second resonant frequency in a second frequency band. Preferably, the first element is connected to a signal feed. In one embodiment, the first element comprises an inverted-F element and the second element comprises a slot element. In another embodiment, the first element comprises an inverted-F element and the second element comprises an inverted L element. In another embodiment of the dual band antenna, the first element comprises a slot element and the second element comprises a slot element. In yet another embodiment, the first element comprises a slot element and the second element comprises an inverted-L element. In another embodiment, the dual-band antenna comprises at least 3 slot elements.

In yet another embodiment of the invention, the antenna comprises a tri-band antenna having a first element having a first resonant frequency in a first frequency band, a second element having a second resonant frequency in a second frequency band, and a third element having a third resonant frequency in a third frequency band. In one embodiment, the first, second and third elements are slot elements. Preferably, the three slot elements are formed adjacent each other and wherein a center slot element is connected to a signal feed.

These and other embodiments, objects, embodiments, features and advantages of the present invention will be described or become apparent from the following detailed description of preferred embodiments, which is to be read in connection with the accompanying drawings.

### BRIEF DESCRIPTION OF THE DRAWINGS

FIG. 1 is a diagram illustrating various conventional embodiments of external antennas for a laptop computer.

FIG. 2 is a diagram illustrating various conventional embodiments of embedded (integrated) antennas for a laptop computer.

FIGS. 3 and 4 are schematic diagrams illustrating novel methods for mounting embedded antennas on a laptop display unit.

FIG. 5 is a schematic diagram illustrating methods for integrally forming antennas on sidewalls of a metallic display cover of a computing device, according to embodiments of the invention.

FIG. 6 is a schematic diagram illustrating methods for integrally forming antennas on areas of a metallic display cover between an display device mounted within the display cover and the sidewalls of the display cover, according to embodiments of the invention.

FIG. 7 is a schematic diagram illustrating a coupled slot antenna according to one embodiment of the present invention.

FIG. 8 is a schematic diagram illustrating methods for integrally forming single-band and dual band antennas on sidewalls of a metallic display cover of a computing device, according to embodiments of the invention.

FIG. 9 is a schematic diagram illustrating methods for integrally forming single-band and dual-band antennas on areas of a metallic display cover between an display device mounted within the display cover and the sidewalls of the display cover, according to embodiments of the invention.

FIG. 10 illustrates a method for feeding antennas using a coaxial transmission line according to an embodiment of the invention.

FIGS. 11(a), (b) and (c) illustrate methods for feeding antennas using a coaxial transmission line according to other embodiments of the invention.

FIG. 12 illustrates experimental results of the measured SWR (standing wave ratio) as a function of frequency in a 2.4 GHz frequency band for a single-band slot antenna that is integrally formed on the sidewall of a metallic display cover of a laptop device.

FIG. 13 is a graphical diagram illustrating experimental results of the measured radiation patterns for a single-band slot antenna that is integrally formed on the sidewall of a metallic display cover of a laptop device.

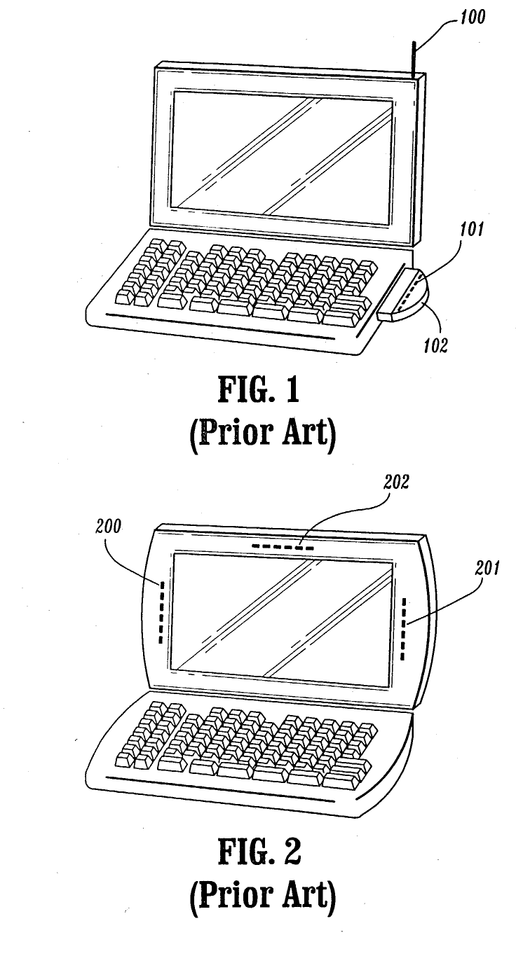

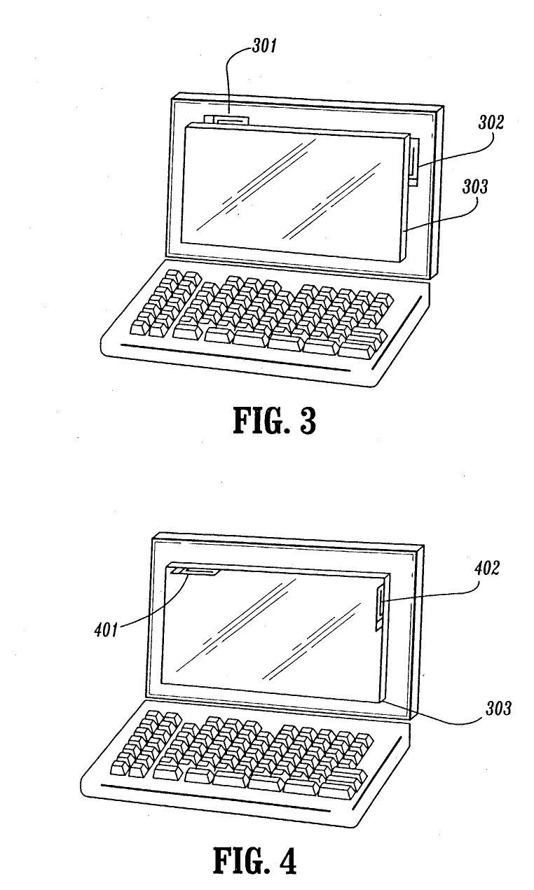

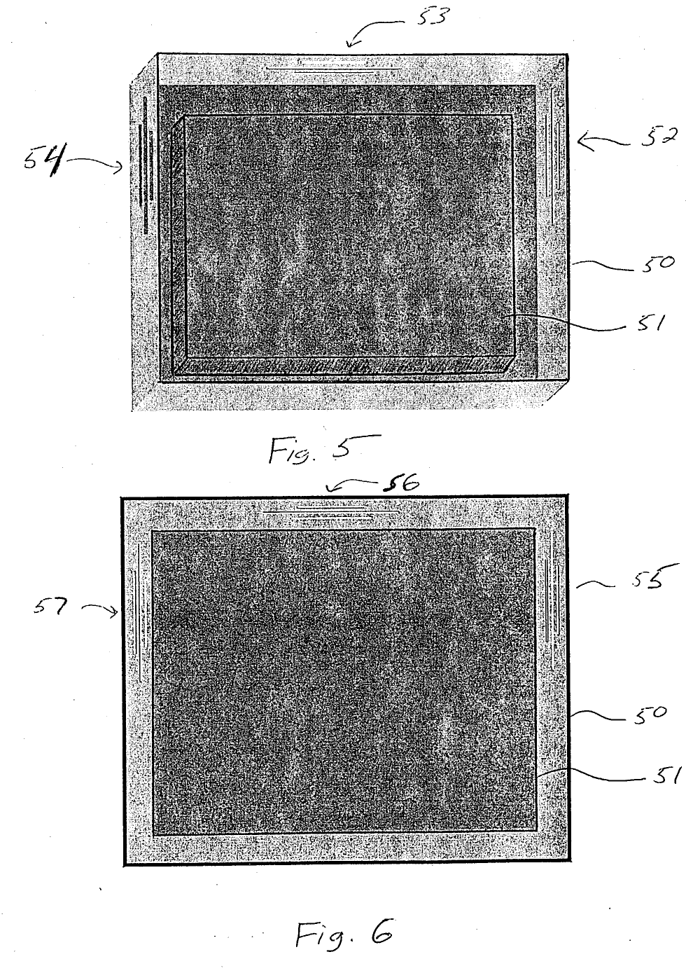

### DETAILED DESCRIPTION OF PREFERRED EMBODIMENTS

The present invention is directed to integrated antennas for use with computing devices such as laptop computers. In general, antennas according to embodiments of the invention are integrally formed with the metallic covering of a computing device. Preferably, the antennas are integrally formed with the metallic cover of a display unit of a laptop device. In one embodiment, one or more antennas are integrally formed on one or more of the bent (side) edges of a metallic cover of a display unit (i.e., sides of the cover that are perpendicular to the plane of an LCD unit). In other embodiments of the invention, one or more antennas are integrally formed on the metallic cover of the display unit in areas between the LCD and the bent (side) edges. There are various advantages associate with integrally forming antennas on a metal display cover including, but not limited to, improved performance, space saving and even low cost.

It is to be appreciated that antennas according to the invention, which are integrally formed on a metallic cover, can be designed using the single-band, dual-band and tri-band antenna frameworks as respectively disclosed in the above incorporated U.S. Pat. No. 6,339,400 and the above-incorporated U.S. patent application Ser. Nos. 10/370,976 and 10/318,816. For example, integrated antennas that may formed from a metallic display cover include, for example, slot antenna and variations/extensions of slot antennas structures, depending on display structure and available space for antennas. In addition, integrated antennas according to the invention can be designed to operate in the ISM and U-NII bands for WLAN applications, and can be implemented for dual-band and tri-band cellular applications.

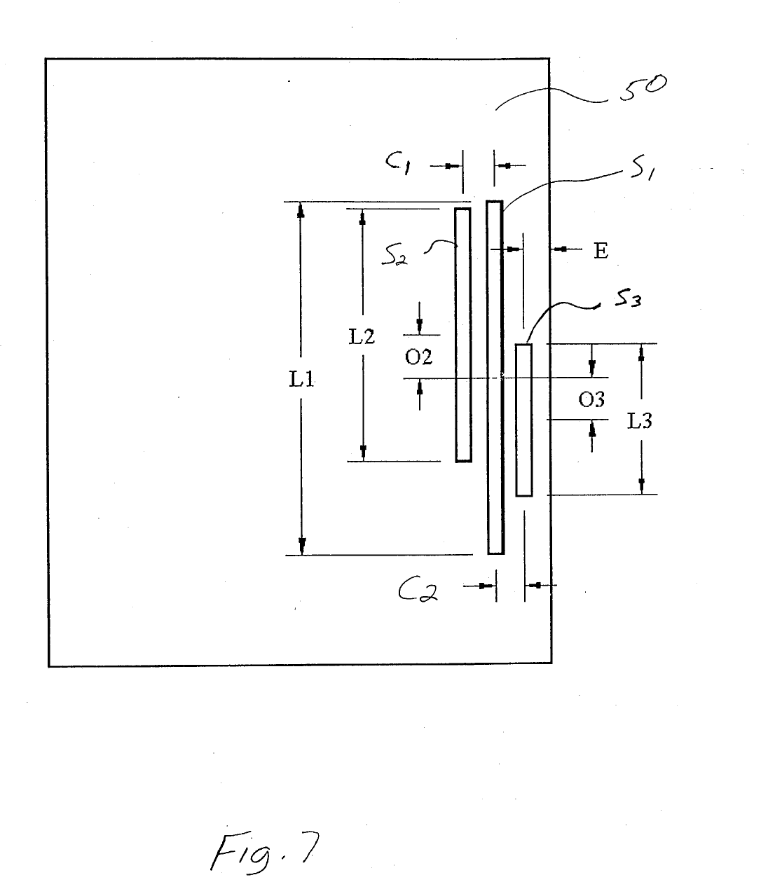

Referring now to FIG. 5, a schematic diagram illustrates various antennas that are integrally formed on the sides of a metallic display cover of a laptop computer, according to an embodiment of the invention. More specifically, FIG. 5 schematically illustrates a display of a laptop computer, wherein the display comprises a metallic cover (50) and a display device (51) (e.g., LCD device). A plurality of antennas (52, 53 and 54) are shown integrally formed in the side edges of the metallic display cover (50). In the exemplary embodiment, each of the integrated antennas comprises a “coupled slot” antenna having three slots, wherein the ground is provided by the metallic cover. Details regarding the operation and tuning of an integrated coupled slot antenna according to the present invention will be discussed below. Preferably, to provide optimal performance of the antennas (52, 53 and 54) integrally formed on the sides of the metallic display cover (50), the slots are preferably disposed above the LCD surface. Indeed, in laptop displays, the display device (51) is typically supported by a metal rim around the perimeter of the display device (51) which can affect the antenna radiation fields.

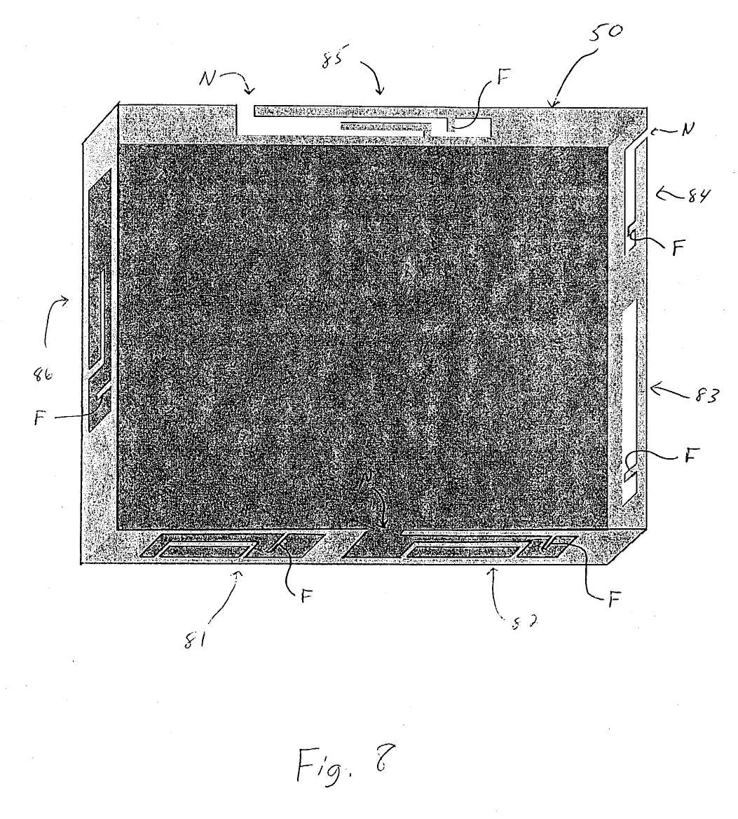

Referring now to FIG. 6, a schematic diagram illustrates various antennas that are integrally formed on the metallic display cover of a laptop computer in areas between the display device and the side edges of the metallic display cover, according to another embodiment of the present invention. More specifically, FIG. 6 schematically illustrates a plurality of antennas (55, 56, 57) that are integrally formed in areas located between the side (bent) edges of the metallic display cover (50) and the LCD device (51). In the exemplary embodiment, each of the integrated antennas (55, 56 and 57) comprises a “coupled slot” antenna having three slots, wherein ground is provided by the metallic cover (50).

FIG. 7 is a schematic diagram illustrating a coupled slot antenna according to one embodiment of the present invention. FIG. 7 further illustrates dimensional parameters that are used for determining operating characteristics of the coupled slot antenna. In the exemplary embodiment, a coupled slot antenna comprises three slots (S1, S2 and S3), wherein signal feed (not shown) is connected to the center slot (i.e., S1), wherein the slots (S2 and S3) are electromagnetically coupled to the center slot (S1), and wherein ground is provided by the metallic cover (50). Preferably, each slot is designed to operate at a resonant (center) frequency in a given frequency band, wherein the slot lengths (L1, L2, L3) of respective slots (S1, S2, S3) are approximately one-half wavelength long at the center (resonant) frequency of the corresponding frequency band.

The antenna feed point primarily determines the antenna impedance, but can have some effect on resonating frequency. The coupling (impedance) can be adjusted by adjusting the coupling distance C1 between the first and second slots (S1, S2) and/or the coupling distance C2 between the first and third slots (S1, S3). In addition, the coupling of the antenna can be adjusted by changing the offset distances O2 and O3, wherein O2 represents the offset of the center point of the length of the second slot (S2) from the center point of the length of the first slot (S1), and wherein O3 represents the offset of the center point of the length of the third slot (S3) from the center point of the length of the first slot (S1). Furthermore, increasing the slot width of a given slot tends to improve the antenna bandwidth.

In FIG. 7, the term “E” represents the distance of the antenna from the “edge” of the metallic display cover. It is to be understood that the “edge” may be actual edge of the cover when the antenna is integrally formed on the side edge of the metallic display over (as depicted in FIG. 5). In addition, the “edge” may be the side wall of the metallic display cover when the antenna is integrally formed in the area between the display device and side wall of the metallic cover (as depicted in FIG. 6). The distance E between the antenna and the display “edge” can affect the antenna performance. Indeed, experiments have shown that antenna performance is adversely affected when the antenna is too close to the “edge”.

In the exemplary embodiments shown in FIGS. 5, 6 and 7, although each coupled slot antenna is depicted as comprising three slots, it is to be appreciated that the coupled slot antennas according to the present invention may comprise one or two slots. In general, a slot antenna comprising a single slot provides single-band operation. A slot antenna comprising two slots can provide dual-band operation, wherein one slot element provides a first resonant frequency in a first band (e.g., 2.4 GHZ ISM band) and a second slot element provides a second resonant frequency in a second band (e.g., 5 Ghz UNII band). With a dual-band coupled slot antenna, the signal feed is preferably connected to the slot element providing operation in the lowest frequency band. It is to be appreciated that a slot antenna comprising two slots can also provide single-band operation, but providing a wider SWR (standing wave ratio) bandwidth as compared to a slot antenna comprising a single slot.

Furthermore, a slot antenna comprising three slot elements can provide tri-band operation, wherein one slot element provides a first resonant frequency in a first band, a second slot element provides a second resonant frequency in a second band, and a third slot provides a third resonant frequency in a third band. It is to be appreciated that a slot antenna comprising three slots can also provide dual-band operation, wherein the center slot (e.g., S1 as shown in FIG. 7) is used for the low band, and the two shorter slots (e.g., S2 and S3) are used for the high band. In such case, in a dual-band coupled slot antenna comprising three slots, the use of two slots for the higher band provides a wider SWR bandwidth as compared to a dual-band slot antenna comprising a two slot elements. In all such embodiments, the signal feed is preferably connected to the slot element providing operation in the lowest frequency band.

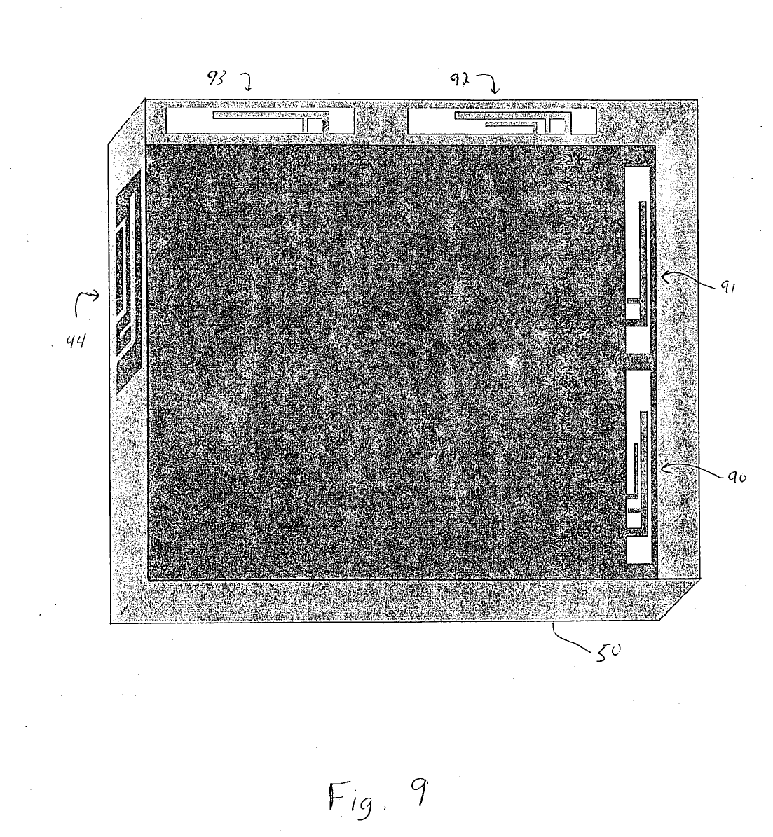

Referring now to FIG. 8, a schematic diagram illustrates various single-band and dual-band antennas that can be integrally formed on the sidewall of the metallic display cover, according to embodiments of the invention. Antenna (81) is a dual-band antenna or “slot-slot dual-band antenna”, comprising a first slot element (outer element) and a second slot (or loop) element (inner element), wherein a feed element (F) is formed on the first slot (outer) element. The feed element F provides means for connecting a signal feed to the antenna (e.g., connecting an inner conductor of a coaxial cable to (F). Antenna (82) is a dual-band antenna or an “inverted F” (INF) dual-band antenna, comprising an inverted-F element (outer element) and slot element (inner element), wherein a feed element (F) is formed on the inverted-F (outer) element. Antennas (83) and (84) are single-band antennas. In particular, the antenna (83) is a single-band slot antenna comprising a single slot element having a feed point (F). The antenna (84) is a single-band INF antenna comprising a single INF element having a feed point (F). Antenna (85) is a dual-band INF antenna comprising an INF element (outer element) and a inverted-L (INL) element (inner element), wherein a feed element (F) is formed on the INF (outer) element. Antenna (86) is a dual-band antenna comprising a slot element (outer element) and an INL element (inner element), wherein a feed element (f) is formed on the slot (outer) element.

It is to be appreciated that the operation and characteristics of the single-band antennas (83, 84) and the dual-band antennas (81, 82, 85, 86) as depicted in FIG. 8 are similar the operation and characteristics of the corresponding antennas frameworks as described, for example, in the above-incorporated U.S. Pat. No. 6,339,400 and patent application Ser. No. 10/370,976, wherein the corresponding antennas are implemented using a metal support structure of the display unit or formed on RF shielding foil. In other words, the antenna impedance and resonate frequencies of the antenna elements for the antenna structures shown in FIG. 8 are tuned/determined in essentially the same way as described in the above-incorporated patents and patent applications. In any event, the process of determining the proper input impedance match for the integrated antennas described herein can be readily performed based on routine experimentation. The experimentation and relationships for different antennas can be readily determined by one of ordinary skill in the art based on the teachings herein.

It is to be appreciated that the single-band slot antenna (83) or the dual-band slot antennas (81, 86) comprising an outer slot element and an inner loop/inverted-L element, as depicted in FIG. 8 can also be built in the area between the LCD and the sidewalls of the metallic display cover. However, the single-band antenna (82) and the dual-band antennas (84 and 85) shown in FIG. 8, which have an outer INF element comprising a notch “N” on the outer edge cannot specifically be formed in the area between the LCD and the sidewalls of the metallic display cover because the “notched” end of the INF element would effectively be shorted by the bottom edge of the sidewall. Furthermore, although the antennas (82, 84 and 85) formed on the sidewall of the metallic display cover provide desirable operating characteristics, the notches N of the INF structures tend to weaken the metallic display covers.

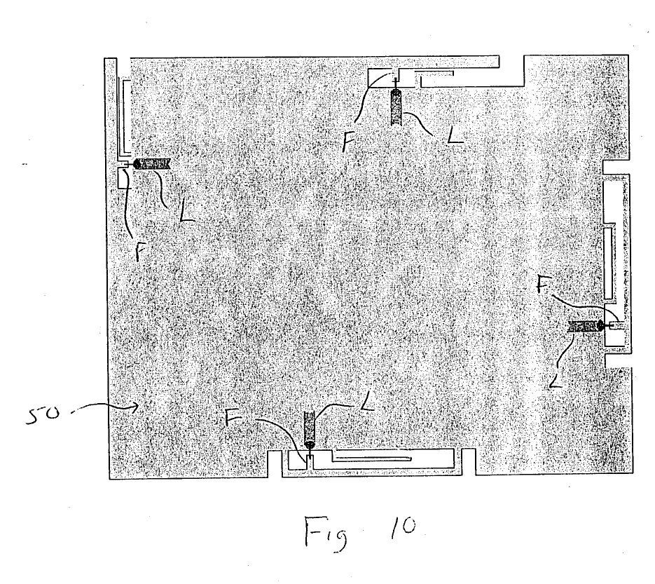

Referring now to FIG. 9, a schematic diagram illustrates various single-band and dual-band antennas that can be integrally formed on the sidewall of a metallic display cover and on the areas between the sidewalls and the display device, according to embodiments of the invention. More specifically, FIG. 9 depicts modified INF antenna structures that do not require notches on the display edges. For example, antennas (90) and (91) are dual-band and single-band antennas, respectively, each comprising an outer INF element that does not touch the sidewall of the metallic display cover (50). Likewise, antennas (92) and (93) are dual-band and single-band antennas, respectively, each comprising an outer INF element that is not formed directly along the sidewall edge of the metallic display cover (50). This is to be contrasted with the single-band antenna (84) and dual-band antenna (85) shown in FIG. 8, wherein the outer INF element is formed directly along the sidewall edge such that the notched end “N” causes a break in the sidewall edge. Further, antenna (94) is a dual-band antenna formed in the sidewall of the cover (50), which is similar to the dual-band antenna (82) of FIG. 8, except that the notched end does not cause a break in the sidewall edge. Although the antenna structures depicted in FIG. 9 provide increase structural integrity of the metallic display cover, such designs can result in less efficient operation due to coupling between the outer INF element and the edge of the sidewall, if they are too close.

FIG. 10 illustrates a method for feeding integrated antennas using a coaxial transmission line (e.g., coaxial cables). In particular, FIG. 10 schematically illustrates a plurality of dual-band antennas as discussed above, wherein the outer elements comprise feed elements F. An antenna feed is preferably implemented using a coaxial transmission line L, wherein an inner conductor of the coaxial transmission line L is connected to the feed portions (F) of the outer elements as shown, and an outer conductor (or outer metal shield) of the coaxial cables are connected to the metallic cover (or other ground plate). This method is applicable for antennas that are integrally formed on the sidewalls of the metallic cover or in the areas between the LCD and sidewalls.

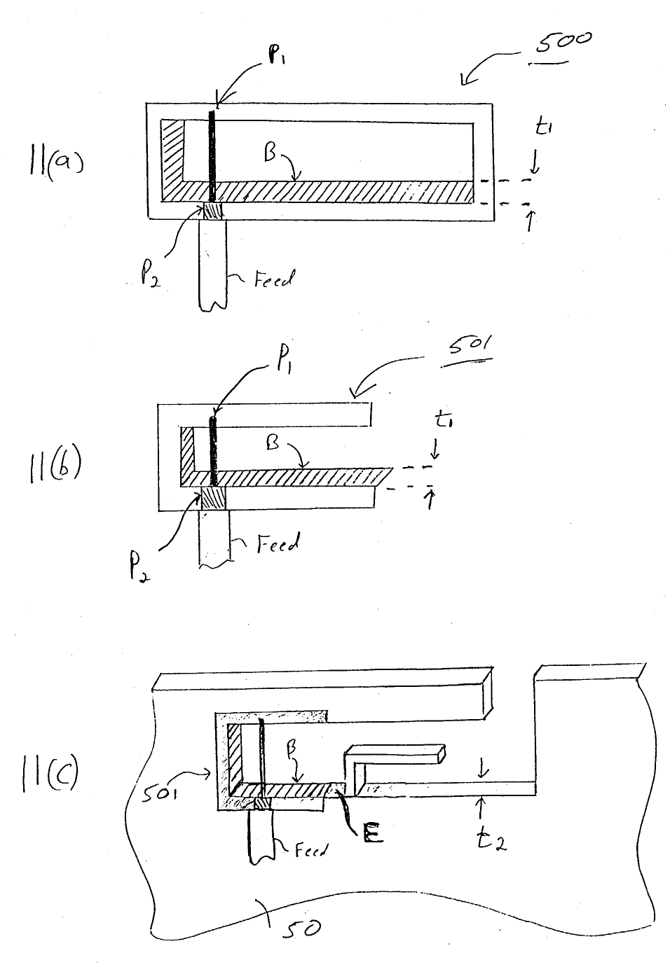

FIGS. 11(a), (b) and (c) illustrate other methods for connecting a feed to an antenna according to exemplary embodiments of the invention. Since metal covers are large and provide a significant heat sink (heat dissipation), it can be difficult to heat a desired soldering point on the metal cover to the temperature that is required to melt the solder and solder the coaxial line at such desired point. Therefore, as shown in FIGS. 11(a) and (b), metallic brackets (500, 501) can be built, whereby the signal feed is first soldered to the brackets, and then the brackets are connected to the appropriate antenna element (see e.g., FIG. 11(c)).

More specifically, FIG. 11(a) illustrates an exemplary bracket (500) for feeding a slot antenna element that is integrally formed, e.g., on a metallic display cover, and FIG. 11(b) illustrates an exemplary bracket (501) for feeding an INF antenna element that is integrally formed, e.g., on a metallic display cover. Each bracket (500, 501) is preferably stamped from a piece of metal, and includes a bent portion (B) which is formed at a 90 degree angle relative to the plane of the bracket. The bent portions (B) of the brackets (500, 501) each have a width (t1) that is substantially equal to the thickness (t2) of the metallic display cover (50) (as shown in FIG. 11(c)). The center conductor of the feed line is first soldered to the brackets (500, 501) at points (P1) and the outer metallic shield (outer conductor) of the feed line is soldered to the brackets (500, 501) at points (P2).

FIG. 11(c) is an exemplary diagram illustrating the bracket (501) insertably mounted on an INF antenna element of a metallic display cover (50). As shown, the bracket (501) is mounted such that bent portions (B) of the bracket (501) contact the edges (E) of the metallic cover (50) and antenna elements. The bracket is preferably held in place, e.g., by resulting pressing force that is generated by the bent portions (B) of the bracket (501) against the edges E when the bracket (501) is inserted, and/or ABS material that is subsequently formed on the sides of the antenna to fill the gaps (i.e., the openings of the metallic display cover that result from the integrally formed antennas are blocked can be filled with ABS material to prevent dust and dirt, for example, from entering the internal cavity of the display unit). Those of ordinary skill in the art can readily envision various methods for mounting the brackets to the antenna elements.

### Experimental Results

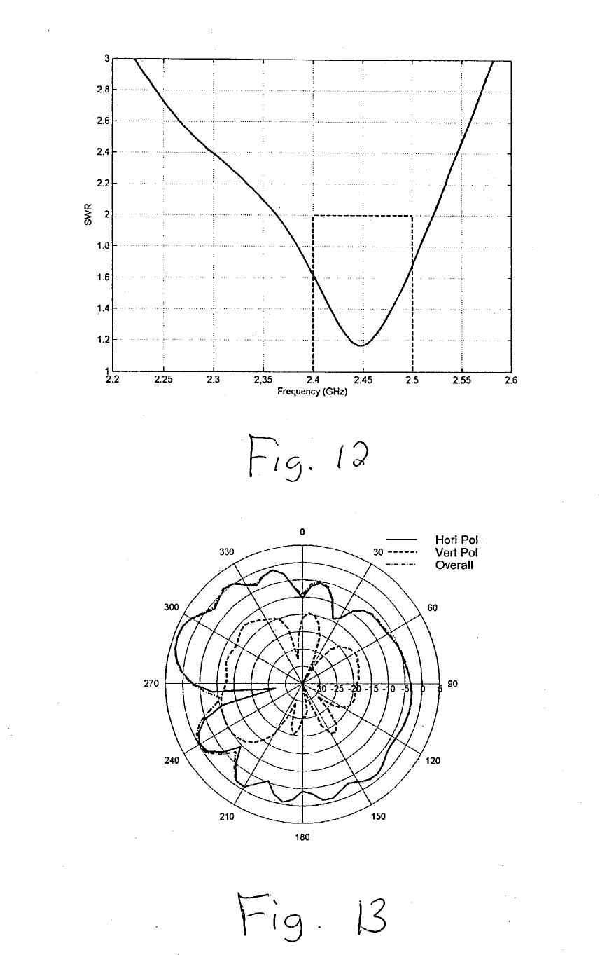

A single-band slot antenna was integrally formed on the sidewall of a metallic display cover of an IBM ThinkPad display unit having a metallic cover. Copper tape was used to obtain good electrical contact between the feed and the metal cover. Then, SWR (standing wave ratio) and radiation measurements were performed for such single-band slot antenna. The results of such measurements are shown in FIGS. 12 and 13.

In particular, FIG. 12 illustrates the measured SWR of the single-band antenna in the 2.4 GHz band. In the exemplary embodiment, the antenna was designed to operate in the 2.4 GHz ISM band (low band). As shown in FIG. 12, for the low band with a center frequency of about 2.45 GHz, the antenna provides sufficient SWR bandwidth (2:1) for the entire band from 2.4 GHz to 2.5 GHz.

FIG. 13 illustrates the measured radiation patterns of the single-band slot antenna at 2.45 GHz on the horizontal plane. The measurement of FIG. 13 were taken when the laptop was open and the angle between the display and the base was about 90 degrees. A receiver was positioned at a certain distance from the laptop as the laptop was rotated 360 degrees, with the single-band antenna transmitting a signal at a frequency of about 2.45 GHz. In FIG. 13, the solid line denotes the horizontal polarization; the dashed line denotes the vertical polarization; and the dash-dot line denotes the overall radiation pattern. When the slot is above the LCD surface, the average gain is from 0.6 to 1.3 dBi, throughout the entire band. The peak gain ranges from 7 to 8 dBi due to reflections and diffractions from the metal display surface. If the slot is partially blocked by the LCD, the antenna gain values can decrease as much as 3 dB. Therefore, it is preferable to provide some clearance for the slot.

Although illustrative embodiments have been described herein with reference to the accompanying drawings, it is to be understood that the present invention is not limited to those precise embodiments, and that various other changes and modifications may be affected therein by one skilled in the art without departing from the scope of the invention.

In the claims:

1. An antenna that is integrally formed on with a metallic cover of a computing device.

2. The antenna of claim 1, wherein the antenna is a single-band antenna having a resonant frequency in a frequency band.

3. The antenna of claim 2, wherein the antenna comprises a slot element.

4. The antenna of claim 2, wherein the antenna comprises an inverted-F element.

5. The antenna of claim 2, wherein the antenna comprises at least 2 slot elements.

6. The antenna of claim 1, wherein the antenna is a dual-band antenna comprising:
a first element having a first resonant frequency in a first frequency band; and
a second element having a second resonant frequency in a second frequency band.

7. The antenna of claim 6, wherein the first element is connected to a signal feed.

8. The antenna of claim 6, wherein the first frequency band is about 2.4 GHz to about 2.5 GHz, and wherein the second frequency band is about 5.15 GHz to about 5.35 GHz.

9. The antenna of claim 6, wherein the first element comprises an inverted-F element and the second element comprises a slot element.

10. The antenna of claim 6, wherein the first element comprises an inverted-F element and the second element comprises an inverted L element.

11. The antenna of claim 6, wherein the first element comprises a slot element and the second element comprises a slot element.

12. The antenna of claim 6, wherein the first element comprises a slot element and the second element comprises an inverted-L element.

13. The antenna of claim 1, wherein the antenna is a dual-band antenna comprising 2 or more slot elements.

14. The antenna of claim 1, wherein the antenna is a tri-band antenna comprising:
a first element having a first resonant frequency in a first frequency band;
a second element having a second resonant frequency in a second frequency band; and
a third element having a third resonant frequency in a third frequency band.

15. The antenna of claim 14, wherein the first, second and third elements are slot elements.

16. The antenna of claim 15, wherein the three slot elements are formed adjacent each other and wherein a center slot element is connected to a signal feed.

17. A computing device, comprising:
a display unit comprising a display screen and a metallic display cover; and
an antenna that is integrally formed with the metallic cover of the display unit.

18. The device of claim 17, wherein metallic display cover comprises first sidewalls that are perpendicular to a plane of the display screen and second sidewalls that are parallel to the plane of the display screen, and wherein the antenna is integrally formed in one of the first or second sidewalls.

19. The antenna of claim 17, wherein the antenna is a single-band antenna having a resonant frequency in a frequency band.

20. The antenna of claim 19, wherein the antenna comprises a slot element.

21. The antenna of claim 19, wherein the antenna comprises an inverted-F element.

22. The antenna of claim 19, wherein the antenna comprises at least 2 slot elements.

23. The antenna of claim 17, wherein the antenna is a dual-band antenna comprising:
a first element having a first resonant frequency in a first frequency band; and
a second element having a second resonant frequency in a second frequency band.

24. The antenna of claim 23, wherein the first element is connected to a signal feed.

25. The antenna of claim 23, wherein the first frequency band is about 2.4 GHz to about 2.5 GHz, and wherein the second frequency band is about 5.15 GHz to about 5.35 GHz.

26. The antenna of claim 23, wherein the first element comprises an inverted-F element and the second element comprises a slot element.

27. The antenna of claim 23, wherein the first element comprises an inverted-F element and the second element comprises an inverted L element.

28. The antenna of claim 23, wherein the first element comprises a slot element and the second element comprises a slot element.

29. The antenna of claim 23, wherein the first element comprises a slot element and the second element comprises an inverted-L element.

30. The antenna of claim 17, wherein the antenna is a dual-band antenna comprising 2 or more slot elements.

31. The antenna of claim 17, wherein the antenna is a tri-band antenna comprising:
a first element having a first resonant frequency in a first frequency band;
a second element having a second resonant frequency in a second frequency band; and
a third element having a third resonant frequency in a third frequency band.

32. The antenna of claim 31, wherein the first, second and third elements are slot elements.

33. The antenna of claim 32, wherein the three slot elements are formed adjacent each other and wherein a center slot element is connected to a signal feed.

34. The antenna of claim 1, wherein one or more radiating elements of the antenna are formed from a portion of the metallic cover.

35. The device of claim 17, wherein one or more radiating elements of the antenna are formed from a portion of the metallic cover.

36. A wireless device, comprising:
a metallic device cover; and
an antenna having one or more radiating elements that are formed from a portion of the metallic display cover.
